(19) United States
(12) Patent Application Publication
(10) Pub. No.: US 2026/0170407 A1
(43) Pub. Date: Jun. 18, 2026

(54) METHOD FOR TRAINING VIDEO LARGE MULTIMODAL MODEL BY ITERATIVE SELF-RETROSPECTIVE JUDGMENT AND LEARNING DEVICE USING THE SAME

(71) Applicants: Seoul National University R&DB Foundation, Seoul (KR); UIF (University Industry Foundation), Yonsei University, Seoul (KR)

(72) Inventors: Jonghyun Choi, Seoul (KR); Daechul Ahn, Seoul (KR); San Kim, Seoul (KR); Yura Choi, Incheon (KR)

(21) Appl. No.: 18/990,195

(22) Filed: Dec. 20, 2024

(30) Foreign Application Priority Data
Dec. 17, 2024 (KR) 10 2024 0188665

(51) Int. Cl. G06N 20/00

(52) U.S. Cl. CPC G06N 20/00

(57) ABSTRACT

A method for training a video large multimodal model (VLMM) by iterative self-retrospective judgment (i-SRT) is provided. The method includes steps of: (i) feeding a (k−1)-th self-retrospective context, video data, and query data into a (k−1)-th trained VLMM, instructing the (k−1)-th trained VLMM to generate a k_th self-retrospective context as to the video data and generate a k_1-st and a k_2-nd responses as to the query data, and thus generating a k_th preference data set, (ii) feeding the k_th preference data set into the (k−1)-th trained VLMM, instructing the (k−1)-th trained VLMM to determine a k_th preference response and a k_th non-preference response, and generating a k_th preference feedback data, and (iii) generating a k_th loss as to the k_th preference feedback data by using a DPO (Direct Preference Optimization) and updating parameters of the (k−1)-th trained VLMM by using the k_th loss, thereby generating a k_th trained VLMM.

### CROSS REFERENCE OF RELATED APPLICATION

This present application claims the benefit of the earlier filing date of Korean non-provisional patent application No. 10-2024-0188665, filed on Dec. 17, 2024, the entire contents of which being incorporated herein by reference.

### FIELD OF THE DISCLOSURE

The present disclosure relates to a method for training a video large multimodal model (VLMM) by iterative self-retrospective judgment (i-SRT) and a learning device using the same.

### BACKGROUND OF THE DISCLOSURE

Large language models (LLMs) are used in conversational AI, such as a ChatGPT. In the past, an RLHF (Reinforcement Learning from Human Feedback) method has been used in order to make the conversational AI to generate human-like answers. Said RLHF method may (i) generate a fine-tuned LLM by performing supervised learning using a high-quality dataset that corresponds to a specific task on a pre-trained LLM, (ii) train a reward model by using training data labeled with human preferences, and (iii) perform reinforcement learning on the fine-tuned LLM by using labeled rewards outputted from the trained reward model.

The RLHF method has an advantage of maximizing the language generation ability and the conversational ability, but it also has disadvantages of (i) requiring the reward model that has been trained, (ii) increasing computation cost caused by sampling output information from the LLM, and (iii) making learning process unstable due to complex computing processes. Therefore, in the past, a DPO (Direct Preference Optimization) method is used to solve the disadvantages described above, since the DPO method can (i) omit the process of training said reward model by allowing the LLM itself to perform the role of said reward model and (ii) optimize the LLM by using preference data.

Recently, some attempts have been made to apply the DPO method not only to the LLM, but also to a video large multimodal model (VLMM). By referring to FIG. 1, as the DPO method is repeatedly applied to the VLMM as illustrated in (A) of FIG. 1, it can be seen that a length of the answer outputted from the VLMM tends to gradually increase. Herein, by referring to (B) of FIG. 1, when video data comprised of multiple frames and query data in a text form are fed into the VLMM, it can be seen that respective lengths of the answers outputted from the VLMM are changed according to the number of iterations, e.g., 1 iteration, 5 iterations, and 9 iterations. However, (i) when the number of iterations of applying the DPO method is small (e.g., 1 iteration and 5 iterations), the answers outputted from the VLMM include contents related to the video data (in bold parts), but (ii) when the number of iterations of applying the DPO method is large (e.g., 9 iterations), the answer outputted from the VLMM includes content unrelated to the video data (in an underlined part), which is called as a hallucination problem.

Accordingly, it is necessary to invent a method for solving these problems.

### SUMMARY OF THE DISCLOSURE

It is an object of the present disclosure to solve all the aforementioned problems.

It is another object of the present disclosure to (i) (i_1) feed video data for training and query data for training into a pre-VLMM, (i_2) instruct the pre-VLMM to generate a 1_st self-retrospective context for training as to the video data for training and to generate two different responses, a 1_1-st response for training and a 1_2-nd response for training, which are corresponding to the query data for training, (ii) (ii_1) feed a 1_st preference data set for training including the video data for training, the query data for training, the 1_st self-retrospective context for training, the 1_1-st response for training, and the 1_2-nd response for training into the pre-VLMM, (ii_2) instruct the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (iii) (iii_1) generate a 1_st loss as to a 1_st preference feedback data for training including the video data for training, the query data for training, the 1_st preference response for training, and the 1_st non-preference response for training and (iii_2) update parameters of the pre-VLMM by using the 1_st loss, thereby generating a 1_st trained VLMM.

It is still another object of the present disclosure to (i) (i_1) feed the video data for training, the query data for training, and the (k−1)-th self-retrospective context for training into a (k−1)-th trained VLMM, (i_2) instruct the (k−1)-th trained VLMM to generate a k_th self-retrospective context for training as to the video data for training and generate two different responses, i.e., a k 1-st response for training and a k 2-nd response for training, which are corresponding to the query data for training, (ii) (ii_1) feed a k_th preference data set for training including the video data for training, the query data for training, the k_th self-retrospective context for training, the k_1-st response for training, and the k_2-nd response for training into the (k−1)-th trained VLMM, (ii_2) instruct the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (iii) (iii_1) generate a k_th loss as to a k_th preference feedback data for training including the video data for training, the query data for training, the k_th preference response for training, and the k_th non-preference response for training and (iii_2) update parameters of the (k−1)-th trained VLMM by using the k_th loss, thereby generating a k_th trained VLMM.

In accordance with one aspect of the present disclosure, there is provided a method for training a video large multimodal model (VLMM) by iterative self-retrospective judgment (i-SRT), including steps of: (a) a learning device, (i) (i_1) feeding video data for training and query data for training in a text form into a pre-VLMM, (i_2) instructing the pre-VLMM to generate a 1_st self-retrospective context for training as to the video data for training and to generate a 1_1-st response for training and a 1_2-nd response for training which are corresponding to the query data for training by referring to the video data for training, wherein the 1_2-nd response for training is different from the 1_1-st response for training, and thus (i_3) generating a 1_st preference data set for training including the 1_st self-retrospective context for training, the 1_1-st response for training, the 1_2-nd response for training, the video data for training, and the query data for training, (ii) (ii_1) feeding the 1_st preference data set for training into the pre-VLMM, (ii_2) instructing the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (ii_3) generating a 1_st preference feedback data for training including the 1_st preference response for training, the 1_st non-preference response for training, the video data for training, and the query data for training, and (iii) generating a 1_st loss as to the 1_st preference feedback data for training by using a DPO (Direct Preference Optimization) and updating parameters of the pre-VLMM by using the 1_st loss, thereby generating a 1_st trained VLMM; and (b) the learning device, (i) (i_1) feeding a (k−1)-th self-retrospective context for training, the video data for training, and the query data for training into a (k−1)-th trained VLMM, wherein the k is an integer increasing from 2 to n, and the n is an integer greater than or equal to 2, (i_2) instructing the (k−1)-th trained VLMM to generate a k_th self-retrospective context for training as to the video data for training by referring to the (k−1)-th self-retrospective context for training and the video data for training and to generate a k_1-st response for training and a k_2-nd response for training which are corresponding to the query data for training by referring to the video data for training, wherein the k_2-nd response for training is different from the k_1-st response for training, and thus (i_3) generating a k_th preference data set for training including the k_th self-retrospective context for training, the k_1-st response for training, the k_2-nd response for training, the video data for training, and the query data for training, (ii) (ii_1) feeding the k_th preference data set for training into the (k−1)-th trained VLMM, (ii_2) instructing the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (ii_3) generating a k_th preference feedback data for training including the k_th preference response for training, the k_th non-preference response for training, the video data for training, and the query data for training, and (iii) generating a k_th loss as to the k_th preference feedback data for training by using the DPO and updating parameters of the (k−1)-th trained VLMM by using the k_th loss, thereby generating a k_th trained VLMM. As one example, at the (iii) of the step of (a), the learning device feeds the video data for training and the query data for training into a reference video large multimodal model (ref-VLMM), wherein the ref-VLMM corresponds to the pre-VLMM, thereby acquiring a reference preference response for training and a reference non-preference response for training, and generates the 1_st loss by referring to each of the 1_st preference response for training and the 1_st non-preference response included in the 1_st preference feedback data for training and each of the reference preference response for training and the reference non-preference response for training, wherein, at the (iii) of the step of (b), the learning device feeds the video data for training and the query data for training into the ref-VLMM, thereby acquiring the reference preference response for training and the reference non-preference response for training, and generates the k_th loss by referring to each of the k_th preference response for training and the k_th non-preference response for training and each of the reference preference response for training and the reference non-preference response for training.

As one example, wherein the ref-VLMM is a supervised learning model and is a base model for generating the 1_st loss and the k_th loss.

As one example, at the step of (a), the learning device (i) sets a temperature hyper-parameter value of the pre-VLMM to be a specific temperature hyper-parameter value, wherein the specific temperature hyper-parameter value is greater than or equal to a predetermined threshold, and (ii) feeds the video data for training and the query data for training into the pre-VLMM, thereby allowing the pre-VLMM to generate each of the 1_1-st response for training and the 1_2-nd response for training by using the specific temperature hyper-parameter value, wherein, at the step of (b), the learning device (i) sets a temperature hyper-parameter value of the (k−1)-th trained VLMM to be the specific temperature hyper-parameter value and (ii) feeds the video data for training and the query data for training into the (k−1)-th trained VLMM, thereby allowing the (k−1)-th trained VLMM to generate each of the k_1-st response for training and the k_2-nd response for training by using the specific temperature hyper-parameter value.

As one example, at the step of (a), the learning device instructs the pre-VLMM to (i) perform embedding on the video data for training and the query data for training in the text form by using an embedding layer, thereby generating a 1_st embedding vector and (ii) generate the 1_1-st response for training and the 1_2-nd response for training by using the 1_st embedding vector through a large language model (LLM), wherein, at the step of (b), the learning device instructs the (k−1)-th trained VLMM to (i) perform embedding on the video data for training and the query data for training by using the embedding layer, thereby generating a k_th embedding vector and (ii) generate the k_1-st response for training and the k_2-nd response for training by using the k-th embedding vector through the LLM.

In accordance with another aspect of the present disclosure, there is provided a learning device for training a video large multimodal model (VLMM) by iterative self-retrospective judgment (i-SRT), including: at least one memory that stores instructions; and at least one processor configured to execute the instructions to perform processes of: (I) (i) (i_1) feeding video data for training and query data for training in a text form into a pre-VLMM, (i_2) instructing the pre-VLMM to generate a 1_st self-retrospective context for training as to the video data for training and to generate a 1_1-st response for training and a 1_2-nd response for training which are corresponding to the query data for training by referring to the video data for training, wherein the 1_2-nd response for training is different from the 1_1-st response for training, and thus (i_3) generating a 1_st preference data set for training including the 1_st self-retrospective context for training, the 1_1-st response for training, the 1_2-nd response for training, the video data for training, and the query data for training, (ii) (ii_1) feeding the 1_st preference data set for training into the pre-VLMM, (ii_2) instructing the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (ii_3) generating a 1_st preference feedback data for training including the 1_st preference response for training, the 1_st non-preference response for training, the video data for training, and the query data for training, and (iii) generating a 1_st loss as to the 1_st preference feedback data for training by using a DPO (Direct Preference Optimization) and updating parameters of the pre-VLMM by using the 1_st loss, thereby generating a 1_st trained VLMM; and (II) (i) (i_1) feeding a (k−1)-th self-retrospective context for training, the video data for training, and the query data for training into a (k−1)-th trained VLMM, wherein the k is an integer increasing from 2 to n, and the n is an integer greater than or equal to 2, (i_2) instructing the (k−1)-th trained VLMM to generate a k_th self-retrospective context for training as to the video data for training by referring to the (k−1)-th self-retrospective context for training and the video data for training and to generate a k_1-st response for training and a k_2-nd response for training which are corresponding to the query data for training by referring to the video data for training, wherein the k_2-nd response for training is different from the k_1-st response for training, and thus (i_3) generating a k_th preference data set for training including the k_th self-retrospective context for training, the k_1-st response for training, the k_2-nd response for training, the video data for training, and the query data for training, (ii) (ii_1) feeding the k_th preference data set for training into the (k−1)-th trained VLMM, (ii_2) instructing the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (ii_3) generating a k_th preference feedback data for training including the k_th preference response for training, the k_th non-preference response for training, the video data for training, and the query data for training, and (iii) generating a k_th loss as to the k_th preference feedback data for training by using the DPO and updating parameters of the (k−1)-th trained VLMM by using the k_th loss, thereby generating a k_th trained VLMM.

As one example, at the (iii) of the process of (I), the processor feeds the video data for training and the query data for training into a reference video large multimodal model (ref-VLMM), wherein the ref-VLMM corresponds to the pre-VLMM, thereby acquiring a reference preference response for training and a reference non-preference response for training, and generates the 1_st loss by referring to each of the 1_st preference response for training and the 1_st non-preference response included in the 1_st preference feedback data for training and each of the reference preference response for training and the reference non-preference response for training, wherein, at the (iii) of the process of (II), the processor feeds the video data for training and the query data for training into the ref-VLMM, thereby acquiring the reference preference response for training and the reference non-preference response for training, and generates the k_th loss by referring to each of the k_th preference response for training and the k_th non-preference response for training and each of the reference preference response for training and the reference non-preference response for training.

As one example, the ref-VLMM is a supervised learning model and is a base model for generating the 1_st loss and the k_th loss.

As one example, at the process of (I), the processor (i) sets a temperature hyper-parameter value of the pre-VLMM to be a specific temperature hyper-parameter value, wherein the specific temperature hyper-parameter value is greater than or equal to a predetermined threshold, and (ii) feeds the video data for training and the query data for training into the pre-VLMM, thereby allowing the pre-VLMM to generate each of the 1_1-st response for training and the 1_2-nd response for training by using the specific temperature hyper-parameter value, wherein, at the process of (II), the processor (i) sets a temperature hyper-parameter value of the (k−1)-th trained VLMM to be the specific temperature hyper-parameter value and (ii) feeds the video data for training and the query data for training into the (k−1)-th trained VLMM, thereby allowing the (k−1)-th trained VLMM to generate each of the k_1-st response for training and the k_2-nd response for training by using the specific temperature hyper-parameter value.

As one example, at the process of (I), the processor instructs the pre-VLMM to (i) perform embedding on the video data for training and the query data for training in the text form by using an embedding layer, thereby generating a 1_st embedding vector and (ii) generate the 1_1-st response for training and the 1_2-nd response for training by using the 1_st embedding vector through a large language model (LLM), wherein, at the process of (II), the processor instructs the (k−1)-th trained VLMM to (i) perform embedding on the video data for training and the query data for training by using the embedding layer, thereby generating a k_th embedding vector and (ii) generate the k_1-st response for training and the k_2-nd response for training by using the k-th embedding vector through the LLM.

### BRIEF DESCRIPTION OF THE DRAWINGS

The above and other objects and features of the present disclosure will become apparent from the following description of preferred embodiments given in conjunction with the accompanying drawings.

The following drawings to be used to explain example embodiments of the present disclosure are only part of example embodiments of the present disclosure and other drawings can be obtained based on the drawings by those skilled in the art of the present disclosure without inventive work.

FIG. 1 is a drawing schematically illustrating an example of a conventional prior art in which a method of DPO is applied to a video large multimodal model (VLMM).

FIG. 2 is a drawing schematically illustrating a configuration of a learning device for training the VLMM by iterative self-retrospective judgment (i-SRT) in accordance with one example embodiment of the present disclosure.

FIG. 3 is a flow chart schematically illustrating a method for training the VLMM by the i-SRT in accordance with one example embodiment of the present disclosure.

FIGS. 4A and 4B are drawings illustrating processes of training the VLMM by the i-SRT in detail in accordance with one example embodiment of the present disclosure.

FIG. 5 is a drawing schematically illustrating an example of a preference data set for training in order to train the VLMM in accordance with one example embodiment of the present disclosure.

FIG. 6 is a drawing schematically illustrating an example of response results generated by each of a trained VLMM of the present disclosure and a conventional VLMM by feeding same data thereinto, on condition that a predetermined cardinal number of iterative training has been completed for each of the trained VLMM of the present disclosure and the conventional VLMM.

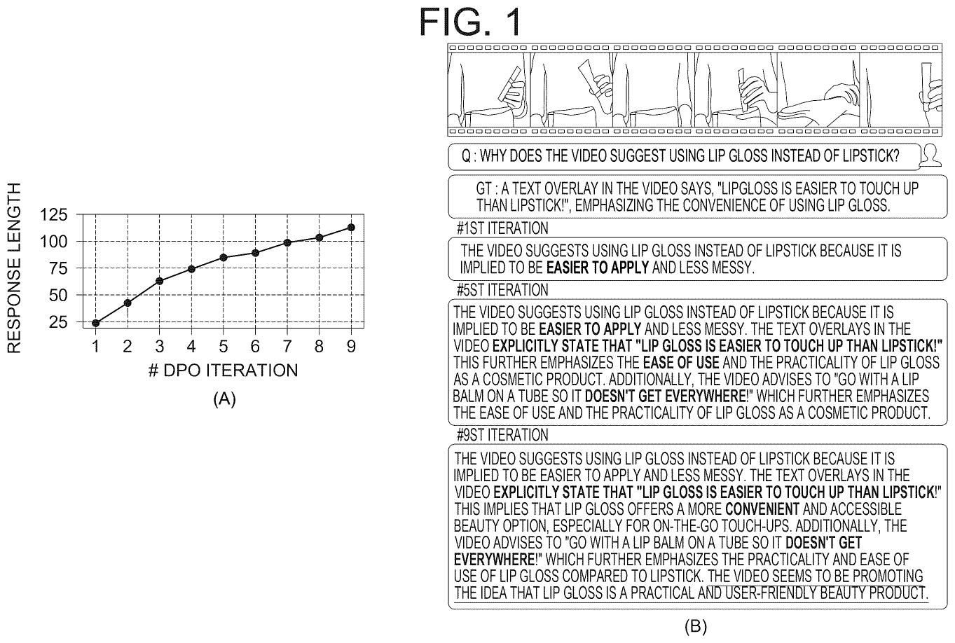

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention.

In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to carry out the present invention easily, the example embodiments of the present invention by referring to attached diagrams will be explained in detail as shown below.

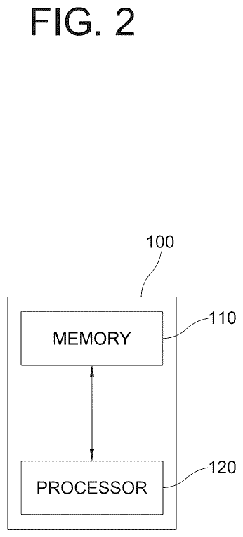

FIG. 2 is a drawing schematically illustrating a configuration of a learning device 100 for training a video large multimodal model (VLMM) by iterative self-retrospective judgment (i-SRT) in accordance with one example embodiment of the present disclosure.

By referring to FIG. 2, the learning device 100 may include a memory 110 that stores instructions for training the VLMM by i-SRT and a processor 120 that trains the VLMM by i-SRT according to the instructions stored in the memory 110. Further, the learning device 100 may further include a PC (personal computer), a mobile computer, etc.

In detail, the learning device 100 may typically use a combination of computing devices (e.g., devices that may include a computer processor, a memory, a storage, input/output devices, and other components of conventional computing devices; electronic communication devices, such as routers, switches, etc.; electronic information storage systems, such as a network attached storage (NAS) and a storage area network (SAN)) and computer software (i.e., instructions that allow the computing device to function in a particular way) to achieve desired system performance.

Further, the processor of the computing device may include a micro processing unit (MPU), or hardware configurations (e.g., a central processing unit (CPU), a cache memory, a data bus, etc.) Further, the computing device may further include an operating system and a software of an application for performing a specific purpose.

However, it does not exclude the case where the computing device includes a medium processor for implementing the present disclosure and an integrated processor in which a memory is integrated.

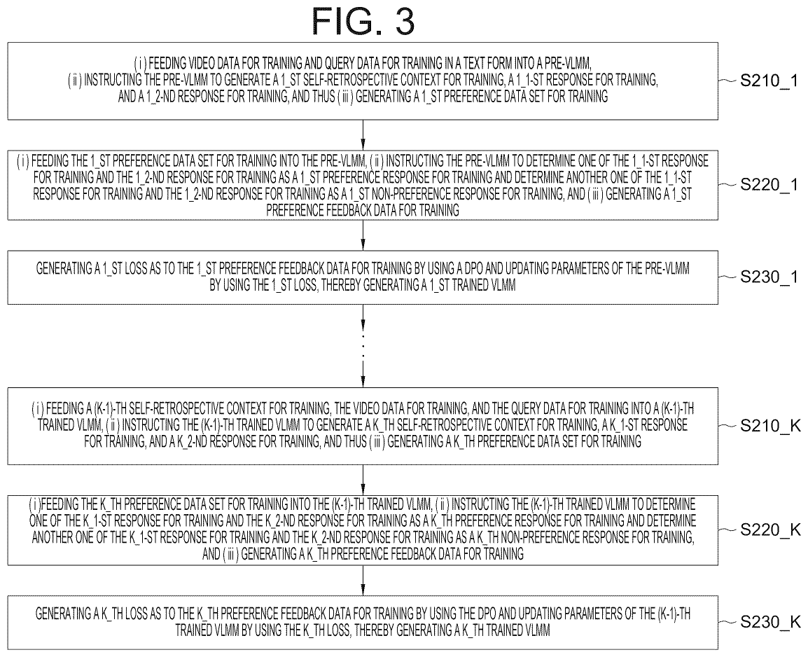

FIG. 3 is a flow chart schematically illustrating a method for training the VLMM by the i-SRT in accordance with one example embodiment of the present disclosure.

First, at a step of S210_1, the learning device 100 may (i) feed video data for training and query data for training in a text form into a pre-VLMM, (ii) instruct the pre-VLMM to generate a 1_st self-retrospective context for training as to the video data for training and to generate a 1_1-st response for training and a 1_2-nd response for training which are corresponding to the query data for training by referring to the video data for training, and thus (iii) generate a 1_st preference data set for training including the 1_st self-retrospective context for training, the 1_1-st response for training, the 1_2-nd response for training, the video data for training, and the query data for training.

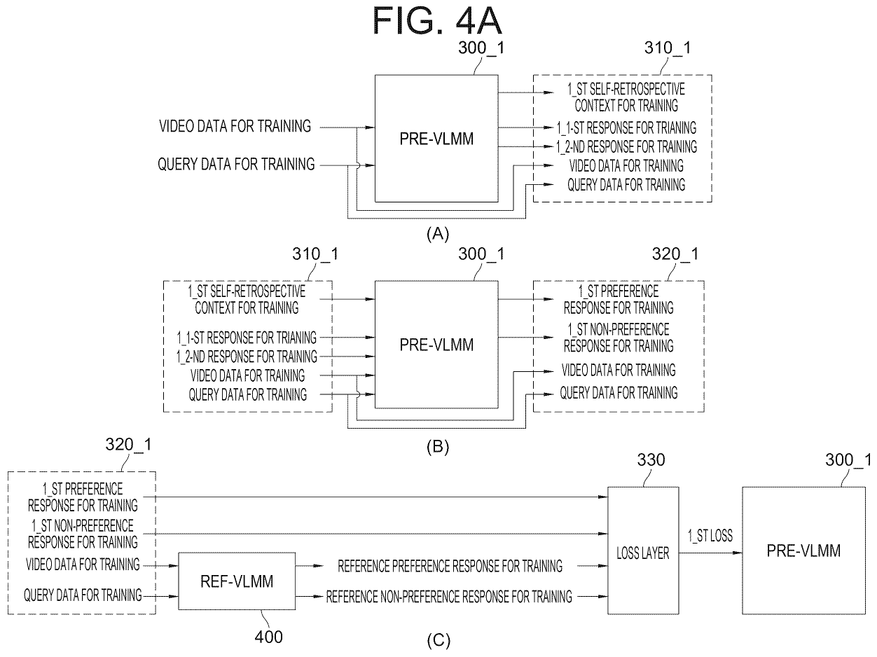

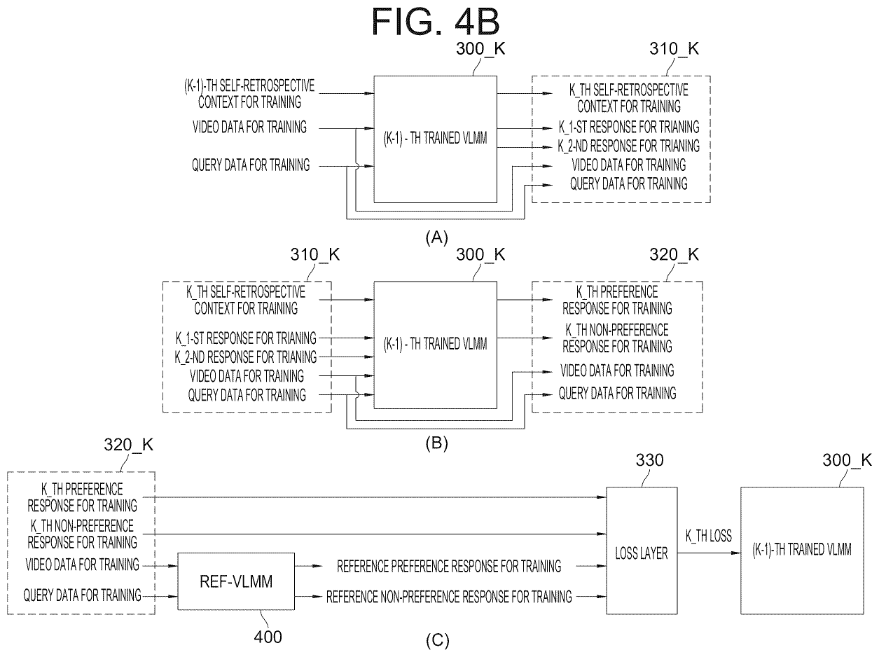

By referring to (A) of FIG. 4A in relation to the step of S210_1, the learning device 100 may set a temperature hyper-parameter value to be a specific temperature hyper-parameter value greater than or equal to a predetermined threshold, thereby generating two different responses, i.e., the 1_1-st response for training and the 1_2-nd response for training, which are corresponding to the query data for training. Herein, the temperature hyper-parameter value relates to an output sensitivity of the pre-VLMM 300_1. For example, if the specific temperature hyper-parameter value is close to 0 (e.g., 0.1), the output sensitivity of the pre-VLMM 300_1 may be low. In contrast, if the specific temperature hyper-parameter value is close to 1 (e.g., 0.7, 0.8, etc.), the output sensitivity of the pre-VLMM 300_1 may be high.

Therefore, the learning device 100 may feed the video data for training and the query data for training into the pre-VLMM 300_1 and instruct the pre-VLMM 300_1 to generate the 1_1-st response for training and the 1_2-nd response for training by using the specific temperature hyper-parameter value. That is, if the specific temperature hyper-parameter value is close to 0, the 1_1-st response for training and the 1_2-nd response for training may be the same or similar. In contrast, if the specific temperature hyper-parameter value is close to 1, the 1_1-st response for training and the 1_2-nd response for training may be different. For example, the learning device 100 of the present disclosure may set the specific temperature hyper-parameter value as 0.7 in order to generate the 1_1-st response for training and the 1_2-nd response for training (which are different with each other) by the pre-VLMM 300_1, but the scope of the present disclosure is not limited thereto.

Herein, the learning device 100 may (i) instruct the pre-VLMM 300_1 to generate two different responses, i.e., the 1_1-st response for training and the 1_2-nd response for training, by feeding the video data for training and the query data for training into the pre-VLMM 300_1 only one time or (ii) instruct the pre-VLMM 300_1 to (ii_1) generate the 1_1-st response for training by feeding the video data for training and the query data for training into the pre-VLMM 300_1 and (ii_2) generate the 1_2-nd response for training, which is different from the 1_1-st response for training, by feeding the video data for training and the query data for training into the pre-VLMM 300_1 again, but the scope of the present disclosure is not limited thereto.

Further, the learning device 100 may instruct the pre-VLMM 300_1 to (i) perform embedding on each of the video data for training and the query data for training in the text form by using an embedding layer, thereby generating a 1_st embedding vector (i.e., the 1_st embedding vector including at least one of vector of embedded video data for training and at least one of vector of embedded query data for training), and (ii) generate the 1_st self-retrospective context for training, the 1_1-st response for training, and the 1_2-nd response for training by using the 1_st embedding vector through a large language model (LLM) included in the pre-VLMM 300_1, but the scope of the present disclosure is not limited thereto.

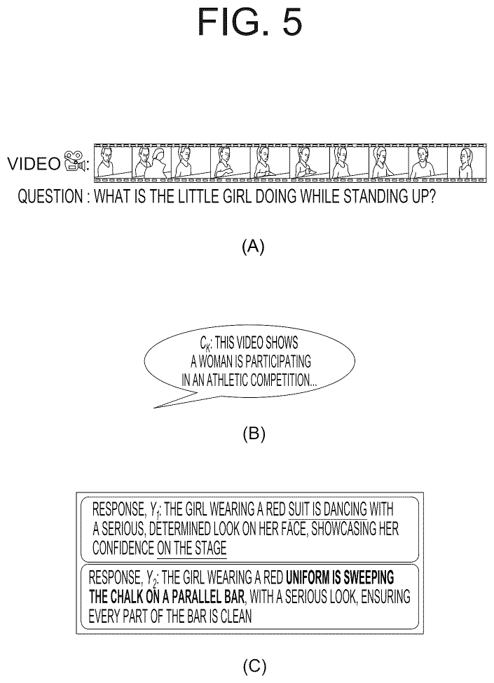

Meanwhile, the learning device 100 may instruct the pre-VLMM 300_1 to generate the 1_st self-retrospective context for training as to the video data for training. Herein, the 1_st self-retrospective context for training is data that describes what the video data for training is or what its state is, and it may be used to determine the preferences for each of the 1_1-st response for training and the 1_2-nd response for training generated by the pre-VLMM 300_1 at the 1_st iteration (i.e., S210_1 to S230_1 in FIG. 3) and may be used to generate a 2 nd self-retrospective context for training that is more specific than the 1_st self-retrospective context for training at the 2_nd iteration. The examples of generating the self-retrospective context will be explained in FIG. 5 later.

As such, the learning device 100 may instruct the pre-VLMM 300_1 to generate the 1_st self-retrospective context for training, the 1_1-st response for training, and the 1_2-nd response for training by using the video data for training and the query data for training, thereby generating the 1_st preference data set for training 310_1 including the 1_st self-retrospective context for training, the 1_1-st response for training, the 1_2-nd response for training, the video data for training, and the query data for training. Herein, the 1_st preference data set for training 310_1 can be used as input data to be fed into the pre-VLMM 300_1 in the subsequent process described later.

Next, by referring to FIG. 3, at a step of S220_1, the learning device 100 may (i) feed the 1_st preference data set for training into the pre-VLMM, (ii) instruct the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (iii) generate a 1_st preference feedback data for training including the 1_st preference response for training, the 1_st non-preference response for training, the video data for training, and the query data for training.

By referring to (B) of FIG. 4A in relation to the step of S220_1, at the step of S210_1, it can be seen that the pre-VLMM 300_1 is used to generate the 1_st self-retrospective context for training, the 1_1-st response for training, and the 1_2-nd response for training, but at the step of S220_1, it can be seen that the pre-VLMM 300_1 is used as a model for judging preferences for each of the 1_1-st response for training and the 1_1-nd response for training by referring to the 1_st preference data set for training 310_1. That is, while the conventional RLHF method judges human preferences by using a reward model, the present disclosure has the characteristic of allowing the pre-VLMM 300_1 to (i) generate two different responses for each of the query data and the self-retrospective context corresponding to the video data and (ii) judge the preferences for the two different responses directly, thereby reducing the amount of computation required for training compared to the conventional RLHF method using the reward model. Further, this also can be applied to the subsequent process of FIG. 4B described later. In addition, the learning device 100 may instruct the pre-VLMM 300_1 to refer to the 1_st self-retrospective context for training when determining each of the 1_st preference response for training and the 1_st non-preference response for training, thereby increasing the accuracy of determining the preferences.

Therefore, the learning device 100 may generate the 1_st preference feedback data for training 320_1 including the 1_st preference response for training, the 1_st non-preference response for training, the video data for training, and the query data for training. Herein, the 1_st preference response for training and the 1_st non-preference response for training are determined by the pre-VLMM 300_1, and the video data for training and the query data for training are included in the 1_st preference data set for training 310_1. Further, the 1_st preference feedback data for training 320_1 may be used to train the pre-VLMM 300_1.

Next, by referring to FIG. 3, at a step of S230_1, the learning device 100 may generate a 1_st loss as to the 1_st preference feedback data for training by using the DPO and update parameters of the pre-VLMM by using the 1_st loss, thereby generating a 1_st trained VLMM.

By referring to (C) of FIG. 4A in relation to the step of S230_1, the learning device 100 may feed the video data for training and the query data for training included in the 1_st preference feedback data for training 320_1 into a reference video large multimodal model (ref-VLMM) 400. Herein, the ref-VLMM 400 corresponds to the pre-VLMM 300_1. Then, the learning device 100 may instruct the ref-VLMM to generate each of a reference preference response for training and a reference non-preference response for training. And then, the learning device 100 may generate the 1_st loss by referring to each of the reference preference response for training and the reference non-preference response for training and each of the 1_st preference response for training and the 1_st non-preference response for training. Herein, each of the 1_st preference response for training and the 1_st non-preference response for training is included in the 1_st preference feedback data for training 320_1. For reference, the ref-VLMM 400 is a pre-supervised learning model using training data for performing a given task and it is used as a base model for generating the 1_st loss. In addition, each of the reference preference response for training and the reference non-preference response for training is used as each of GT (ground truth) s for each of the 1_st preference response for training and the 1_st non-preference response for training.

In detail, the learning device 100 may (i) feed the 1_st preference response for training, the 1_st non-preference response for training, the reference preference response for training, and the reference non-preference response for training into the loss layer 330, (ii) replace a reward model for the preference response by referring to a ratio of the 1_st preference response for training to the reference preference response for training though the loss layer 330 and replace a reward model for the non-preference response by referring to a ratio of the 1_st non-preference response for training to the reference non-preference response for training through the loss layer 330, thereby generating the 1_st loss.

Therefore, in case the 1_st loss is generated through the loss layer 330, the learning device 100 may update the parameters of the pre-VLMM 300_1 by using the 1_st loss, thereby generating the 1_st trained VLMM.

As such, if the 1_st iteration is completed through the aforementioned process and thus the 1_st trained VLMM is generated, the learning device 100 may perform the 2 nd iteration to an n_th iteration by repeating processes identical to or similar to the 1_st iteration. To explain processes of the 2_nd iteration to the n_th iteration easily, a parameter k may be introduced. Herein, the k is an integer increasing from 2 to n. Accordingly, a process of a k_th iteration may be explained as follows.

By referring to FIG. 3, at a step of S210_k, the learning device 100 may (i) feed a (k−1)-th self-retrospective context for training, the video data for training, and the query data for training into a (k−1)-th trained VLMM, (ii) instruct the (k−1)-th trained VLMM to generate a k_th self-retrospective context for training as to the video data for training by referring to the (k−1)-th self-retrospective context for training and the video data for training and to generate a k_1-st response for training and a k_2-nd response for training which are corresponding to the query data for training by referring to the video data for training, and thus (iii) generate a k_th preference data set for training including the k_th self-retrospective context for training, the k_1-st response for training, the k_2-nd response for training, the video data for training, and the query data for training.

By referring to (A) of FIG. 4B in relation to the step of S210_k, it can be seen that the leaning device 100 feeds not only the video data for training and the query data for training (same as those fed at the 1_st iteration), but also the (k−1)-th self-retrospective context for training (acquired at the previous iteration) into the (k−1)-th trained VLMM 300_k, while the learning device 100 feeds the video data for training and the query data for training only into the pre-VLMM 300_1 at the 1_st iteration as shown in the process (A) of FIG. 4A). Therefore, the process of the k_th iteration is different from the process of the 1_st iteration.

That is, at the k_th iteration, the learning device 100 may instruct the (k−1)-th trained VLMM 300_k to refer to the (k−1)-th self-retrospective context for training acquired at the previous iteration, thereby allowing the (k−1)-th trained VLMM 300_k to generate a context for the video data for training more specifically and richer (i.e., the k_th self-retrospective context for training).

Further, like the 1_st iteration, the learning device 100 may make the k_2-nd response for training generated from the (k−1)-th trained VLMM 300_k different from the k_1-st response for training.

In detail, the learning device 100 may (i) set a temperature hyper-parameter value of the (k−1)-th trained VLMM to be the specific temperature hyper-parameter value and (ii) feed the video data for training and the query data for training into the (k−1)-th trained VLMM, thereby allowing the (k−1)-th trained VLMM to generate each of the k_1-st response for training and the k_2-nd response for training by using the specific temperature hyper-parameter value.

Herein, the learning device 100 may (i) instruct the (k−1)-th trained VLMM to generate two different responses, i.e., the k_1-st response for training and the k_2-nd response for training, by feeding the video data for training and the query data for training into the (k−1)-th trained VLMM only one time or (ii) instruct the (k−1)-th trained VLMM to (ii_1) generate the k_1-st response for training by feeding the video data for training and the query data for training into the (k−1)-th trained VLMM and (ii_2) generate the k_2-nd response for training, which is different from the k_1-st response for training, by feeding the video data for training and the query data for training into the (k−1)-th trained VLMM again, but the scope of the present disclosure is not limited thereto.

Further, the learning device 100 may instruct the (k−1)-th trained VLMM 300_k to (i) perform embedding on each of the video data for training and the query data for training by using the embedding layer, thereby generating a k_th embedding vector (i.e., the k_th embedding vector including at least one of vector of embedded video data for training and at least one of vector of embedded query data for training), and (ii) generate the k_th self-retrospective context for training, the k_1-st response for training, and the k_2-nd response for training by using the k_th embedding vector through the LLM.

As such, the learning device 100 may instruct the (k−1)-th trained VLMM 300_k to generate the k_th self-retrospective context for training, the k_1-th response for training, and the k_2-nd response for training by using the video data for training and the query data for training, thereby generating the k_th preference data set for training 310_k comprised of the k_th self-retrospective context for training, the k_1-th response for training, the k_2-nd response for training, the video data for training, and the query data for training. Herein, the k_th preference data set for training 310_k can be used as input data to be fed into the (k−1)-th trained VLMM 300_k in the subsequent process described later. Herein, the examples of generating the k_th preference data set for training 310_k will be explained in FIG. 5 below.

FIG. 5 is a drawing schematically illustrating an example of the preference data set for training in order to train the VLMM in accordance with one example embodiment of the present disclosure.

First, it can be seen that examples of the video data for training and the query data for training are illustrated in (A) of FIG. 5, an example of the k_th self-retrospective context for training is illustrated in (B) of FIG. 5, and examples of the k_1-st response for training and the k_2-nd response for training are illustrated in (C) of FIG. 5.

Herein, (i) each of the video data for training and the query data for training may be identically used repeatedly from the 1_st iteration to the n_th iteration, (ii) the k_th self-retrospective context for training may be generated through the (k−1)-th trained VLMM by referring to the (k−1)-th self-retrospective context for training and the video data for training, and (iii) each of the k_1-st response for training and the k_2-nd response for training may be generated through the (k−1)-th trained VLMM by referring to the video data for training and the query data for training.

Further, by referring to the k_1-st response for training (e.g., y₁), it can be seen that some of the content is underlined, which indicates that the underlined content is unrelated to the video data for learning, and by referring to the k_2-nd response for training (e.g., y₂), it can be seen that other some of the content is shown in bold, which indicates that the content in bold is related to the video data for learning, but the scope of the present disclosure is not limited thereto. For example, in case the k_1-st response for training and the k_2-nd response for training are generated as described above, the learning device 100 may instruct the (k−1)-th trained VLMM to determine the k_1-st response for training as a non-preference response and the k_2-nd response for training as a preference response at a subsequent process described later.

Next, by referring back to FIG. 3, at a step of S220_k, the learning device 100 may (i) feed the k_th preference data set for training into the (k−1)-th trained VLMM, (ii) instruct the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (iii) generate a k_th preference feedback data for training including the k_th preference response for training, the k_th non-preference response for training, the video data for training, and the query data for training.

By referring to (B) of FIG. 4B in relation to the step of S220_k, at the step of S210_k, it can be seen that the (k−1)-th trained VLMM 300_k is used to generate the k_th self-retrospective context for training, the k_1-st response for training, and the k_2-nd response for training, but at the step of S220_k, it can be seen that the (k−1)-th trained VLMM 300_k is used as a model for judging preferences for each of the k_1-st response for training and the k_2-nd response for training by referring to the k_th preference data set for training 310_k. In addition, the learning device 100 may instruct the (k−1)-th trained VLMM 300_k to refer to the k_th self-retrospective context for training when determining each of the k_th preference response for training and the k_th non-preference response for training, thereby increasing the accuracy of determining the preferences.

Therefore, the learning device 100 may generate the k_th preference feedback data for training 320_k including the k_th preference response for training and the k_th non-preference response for training, the video data for training, and the query data for training. Herein, the k_th preference response for training and the k_th non-preference response for training are determined by the (k−1)-th trained VLMM 300_k, and the video data for training and the query data for training are included in the k_th preference data set for training 310_k. Further, the k_th preference feedback data for training 320_k may be used to train the (k−1)-th trained VLMM 300_k.

Next, by referring back to FIG. 3, at a step of S230_k, the learning device 100 may generate a k_th loss as to the k_th preference feedback data for training by using the DPO and update parameters of the (k−1)-th trained VLMM by using the k_th loss, thereby generating a k_th trained VLMM.

By referring to (C) of FIG. 4B in relation to the step of S230_k, the learning device 100 may feed the video data for training and the query data for training included in the k_th preference feedback data for training 320_k into the reference video large multimodal model (ref-VLMM) 400. Herein, the ref-VLMM 400 corresponds to the (k−1)-th trained VLMM 300_k. Then, the learning device 100 may instruct the ref-VLMM 400 to output each of a reference preference response for training and a reference non-preference response for training. And then, the learning device 100 may generate the k_th loss by referring to each of the reference preference response for training and the reference non-preference response for training and each of the k_th preference response for training and the k_th non-preference response for training. Herein, each of the k_th preference response for training and the k_th non-preference response for training is included in the k_th preference feedback data for training 320_k. For reference, the ref-VLMM 400 is a pre-supervised learning model using training data for performing a given task and is used as a base model for generating the k_th loss. In addition, each of the reference preference response for training and the reference non-preference response for training is used as each of GTs for each of the k_th preference response for training and the k_th non-preference response for training.

In detail, the learning device 100 may (i) feed the k_th preference response for training, the k_th non-preference response for training, the reference preference response for training, and the reference non-preference response for training into the loss layer 330, (ii) replace a reward model for the preference response by referring to a ratio of the k_th preference response for training to the reference preference response for training though the loss layer 330 and replace a reward model for the non-preference response by referring to a ratio of the k_th non-preference response for training to the reference non-preference response for training through the loss layer 330, thereby generating the k_th loss.

Herein, the k_th loss can be defined as follows:

$${ℒ}_{DPO} ( {π}_{{θ}^{k}} ; {π}_{ref , k} ) = - {𝔼}_{( V , x , {y}_{w} , {y}_{l} ) \sim {𝒟}_{k}^{ref}} [ log σ ( β log \frac{{π}_{{θ}^{k}} ( {y}_{w} \vert V , x )}{{π}_{ref , k} ( {y}_{w} \vert V , x )} - β log \frac{{π}_{{θ}^{k}} ( {y}_{l} \vert V , x )}{{π}_{ref , k} ( {y}_{l} \vert V , x )} ) ]$$

Herein, π_{θ}_{^{k}} may denote the (k−1)-th trained VLMM 300k, π_{ref,k} may denote the ref-VLMM 400, V may denote the video data for training, x may denote the query data for training, y_{w} may denote the k_th preference response for training, yₗ may denote the k_th non-preference response for training,

$${D}_{k}^{pref}$$

may denote the k_th preference data set for training, β may denote a parameter for controlling a deviation between the (k−1)-th trained VLMM 300_k and the ref-VLMM 400, and σ may denote a sigmoid function, but they are not limited thereto.

Therefore, in case the k_th loss is generated through the loss layer 330, the learning device 100 may update the parameters of the (k−1)-th trained VLMM 300_k by using the k_th loss, thereby generating the k_th trained VLMM.

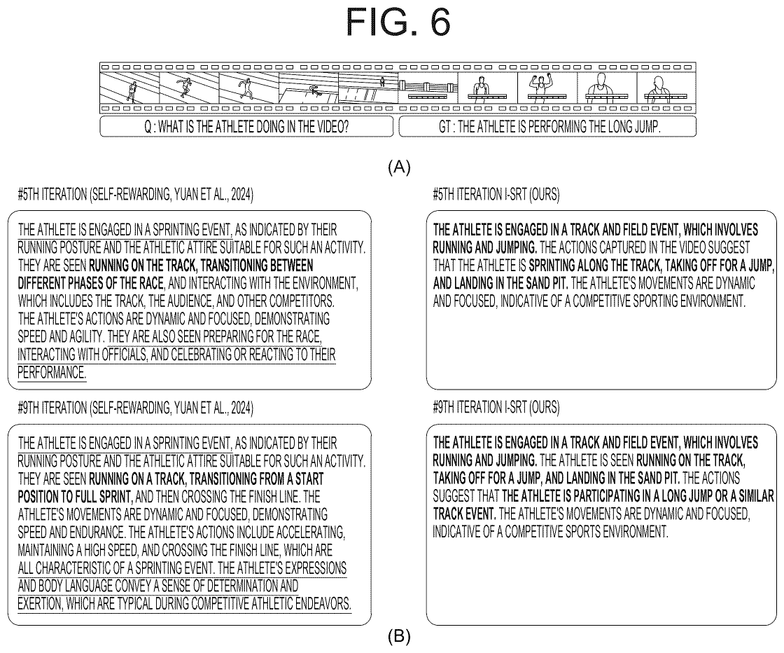

Meanwhile, results of comparing the differences in response results generated by each of the trained VLMM of the present disclosure and the conventional VLMM by feeding same data thereinto will be explained in FIG. 6 below.

FIG. 6 is a drawing schematically illustrating an example of response results generated by each of the trained VLMM of the present disclosure and the conventional VLMM by feeding same data thereinto, on condition that a predetermined cardinal number of iterative training has been completed for each of the trained VLMM of the present disclosure and the conventional VLMM.

By referring to (A) of FIG. 6, video data related to an athlete doing a long jump and query data related to asking what the athlete is doing are illustrated. Herein, the results of feeding the video data and the query data into each of the trained VLMM of the present disclosure and the conventional VLMM will be described below.

By referring to (B) of FIG. 6, it can be seen that each response result generated by each of the trained VLMM of the present disclosure and the conventional VLMM when 5 iterations are applied to each of the trained VLMM of the present disclosure and the conventional VLMM. In detail, it can be seen that the response result generated by the conventional VLMM includes a content related to the video data (shown in bold) and contents unrelated to the video data (shown in underlined parts), but the response result generated by the trained VLMM of the present disclosure only includes contents related to the video data (shown in bold). That is, the response result generated by the trained VLMM of the present disclosure does not include any wrong content.

Further, in case 9 iterations are applied to each of the trained VLMM of the present disclosure and the conventional VLMM, it can be seen that the response result generated by the conventional VLMM includes contents unrelated to the video data (shown in underlined parts) more than a content related to the video data (shown in bold), but the response result generated by the trained VLMM of the present disclosure includes contents related to the video data (shown in bold) more specifically. That is, when the trained VLMM of the present disclosure generates the response result corresponding to the query data by referring to the video data through the learning method of the present disclosure, the response result generated can be described more specifically as the number of iteration increases, and thus it does not include the content unrelated to the video data.

Meanwhile, the excellence of the method for training VLMM by i-SRT in accordance with one example embodiment of the present disclosure will be described below.

| | ActivityNet-QA | | VIDAL-QA | | WebVid-QA | |
|---|---|---|---|---|---|---|
| Methods | Acc. | Score | Acc. | Score | Acc. | Score |
| Video-ChatGPT (Maaz et al., 2024) | 34.17 | 2.19 | 29.35 | 2.10 | 38.88 | 2.27 |
| LLaMA-VID (Li et al., 2023b) | 36.54 | 2.27 | 30.58 | 2.15 | 36.99 | 2.24 |
| Chat-UniVi (Jin et al., 2023) | 39.35 | 2.32 | 31.40 | 2.16 | 40.05 | 2.31 |
| Video-LLaVA (Lin et al., 2023) | 41.35 | 2.38 | 34.30 | 2.24 | 42.47 | 2.39 |
| VLM-RLAIF (Ahn et al., 2024) | 53.27 | 2.56 | 44.82 | 2.40 | 53.69 | 2.62 |
| PLLaVA† (Xu et al., 2024) | 48.44 | 2.50 | 42.45 | 2.39 | 53.55 | 2.59 |
| LLaVA-NeXT-DPO† (Zhang et al., 2024b) | 68.05 | 2.88 | 61.52 | 2.72 | 73.35 | 3.00 |
| LLaVA-Hound-DPO† (Zhang et al., 2024a) | 76.62 | 3.18 | 70.06 | 3.04 | 79.82 | 3.29 |
| i-SRT | 82.99 | 3.26 | 79.00 | 3.13 | 88.11 | 3.40 |

The above experimental result shows that the difference in performance between the present disclosure (i-SRT) and conventional prior arts by using in-domain Zero-shot VQA (video question answering) datasets.

In detail, for each of the datasets (Activity Net-QA, VIDAL-QA, and WebVid-QA), it can be seen that the accuracy and the score of the present disclosure (shown in bold) are higher than those of the prior art. That is, it can be confirmed that the performance of the present disclosure (i.e., the i-SRT) is the best.

| | MSVD-QA | | MSRVTT-QA | | TGIF-QA | | SSV2-QA | |
|---|---|---|---|---|---|---|---|---|
| Methods | Acc. | Score | Acc. | Score | Acc. | Score | Acc. | Score |
| Video-ChatGPT (Maaz et al., 2024) | 34.06 | 2.20 | 25.65 | 1.98 | 31.35 | 2.09 | 19.36 | 1.75 |
| LLaMA-VID (Li et al., 2023b) | 34.14 | 2.21 | 25.02 | 1.99 | 27.18 | 2.00 | 22.16 | 1.84 |
| Chat-UniVi (Jin et al., 2023) | 35.61 | 2.23 | 25.89 | 2.01 | 33.23 | 2.13 | 20.59 | 1.79 |
| Video-LLaVA (Lin et al., 2023) | 39.46 | 2.37 | 30.78 | 2.15 | 32.95 | 2.18 | 24.31 | 1.90 |
| VLM-RLAIF (Ahn et al., 2024) | 51.16 | 2.55 | 41.44 | 2.30 | 46.52 | 2.41 | 29.78 | 1.94 |
| PLLaVA† (Xu et al., 2024) | 48.92 | 2.53 | 38.26 | 2.28 | 43.83 | 2.40 | 30.92 | 2.07 |
| LLaVA-NeXT-DPO† (Zhang et al., 2024b) | 65.08 | 2.82 | 59.12 | 2.65 | 60.80 | 2.70 | 40.14 | 2.24 |
| LLaVA-Hound-DPO† (Zhang et al., 2024a) | 73.64 | 3.12 | 68.29 | 2.98 | 74.00 | 3.12 | 48.89 | 2.53 |
| i-SRT | 80.36 | 3.20 | 75.42 | 3.05 | 78.58 | 3.12 | 54.66 | 2.59 |

The above experimental result shows that the difference in performance between the present disclosure (i-SRT) and conventional prior arts by using Out-domain Zero-shot VQA (video question answering) datasets.

In detail, for each of the datasets (MSVD-QA, MSRVTT-QA, TGIF-QA, and SSV2-QA), it can be seen that the accuracy and the score of the present disclosure (shown in bold) are higher than those of the prior art. That is, it can be confirmed that the performance of the present disclosure (i.e., the i-SRT) is the best.

The present disclosure has an effect of (i) (i_1) feeding video data for training and query data for training into a pre-VLMM, (i_2) instructing the pre-VLMM to generate a 1_st self-retrospective context for training as to the video data for training and to generate two different responses, a 1_1-st response for training and a 1_2-nd response for training, which are corresponding to the query data for training, (ii) (ii_1) feeding a 1_st preference data set for training including the video data for training, the query data for training, the 1_st self-retrospective context for training, the 1_1-st response for training, and the 1_2-nd response for training into the pre-VLMM, (ii_2) instructing the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (iii) (iii_1) generating a 1_st loss as to a 1_st preference feedback data for training including the video data for training, the query data for training, the 1_st preference response for training, and the 1_st non-preference response for training and (iii_2) updating parameters of the pre-VLMM by using the 1_st loss, thereby generating a 1_st trained VLMM.

The present disclosure has another effect of (i) (i_1) feeding the video data for training, the query data for training, and the (k−1)-th self-retrospective context for training into a (k−1)-th trained VLMM, (i_2) instructing the (k−1)-th trained VLMM to generate a k_th self-retrospective context for training as to the video data for training and generate two different responses, a k_1-st response for training and a k_2-nd response for training, which are corresponding to the query data for training, (ii) (ii_1) feeding a k_th preference data set for training including the video data for training, the query data for training, the k_th self-retrospective context for training, the k_1-st response for training, and the k_2-nd response for training into the (k−1)-th trained VLMM, (ii_2) instructing the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (iii) (iii_1) generating a k_th loss as to a k_th preference feedback data for training including the video data for training, the query data for training, the k_th preference response for training, and the k_th non-preference response for training and (iii_2) updating parameters of the (k−1)-th trained VLMM by using the k_th loss, thereby generating a k_th trained VLMM.

Further, the embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present disclosure has been explained by specific matters such as detailed components, limited embodiments, and drawings. They have been provided only to help more general understanding of the present invention. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for training a video large multimodal model (VLMM) by iterative self-retrospective judgment (i-SRT), comprising steps of:
(a) a learning device, (i) (i_1) feeding video data for training and query data for training in a text form into a pre-VLMM, (i_2) instructing the pre-VLMM to generate a 1_st self-retrospective context for training as to the video data for training and to generate a 1_1-st response for training and a 1_2-nd response for training which are corresponding to the query data for training by referring to the video data for training, wherein the 1_2-nd response for training is different from the 1_1-st response for training, and thus (i_3) generating a 1_st preference data set for training including the 1_st self-retrospective context for training, the 1_1-st response for training, the 1_2-nd response for training, the video data for training, and the query data for training, (ii) (ii_1) feeding the 1_st preference data set for training into the pre-VLMM, (ii_2) instructing the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (ii_3) generating a 1_st preference feedback data for training including the 1_st preference response for training, the 1_st non-preference response for training, the video data for training, and the query data for training, and (iii) generating a 1_st loss as to the 1_st preference feedback data for training by using a DPO (Direct Preference Optimization) and updating parameters of the pre-VLMM by using the 1_st loss, thereby generating a 1_st trained VLMM; and
(b) the learning device, (i) (i_1) feeding a (k−1)-th self-retrospective context for training, the video data for training, and the query data for training into a (k−1)-th trained VLMM, wherein the k is an integer increasing from 2 to n, and the n is an integer greater than or equal to 2, (i_2) instructing the (k−1)-th trained VLMM to generate a k_th self-retrospective context for training as to the video data for training by referring to the (k−1)-th self-retrospective context for training and the video data for training and to generate a k_1-st response for training and a k_2-nd response for training which are corresponding to the query data for training by referring to the video data for training, wherein the k_2-nd response for training is different from the k_1-st response for training, and thus (i_3) generating a k_th preference data set for training including the k_th self-retrospective context for training, the k_1-st response for training, the k_2-nd response for training, the video data for training, and the query data for training, (ii) (ii_1) feeding the k_th preference data set for training into the (k−1)-th trained VLMM, (ii_2) instructing the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (ii_3) generating a k_th preference feedback data for training including the k_th preference response for training, the k_th non-preference response for training, the video data for training, and the query data for training, and (iii) generating a k_th loss as to the k_th preference feedback data for training by using the DPO and updating parameters of the (k−1)-th trained VLMM by using the k_th loss, thereby generating a k_th trained VLMM.

2. The method of claim 1, wherein, at the (iii) of the step of (a), the learning device feeds the video data for training and the query data for training into a reference video large multimodal model (ref-VLMM), wherein the ref-VLMM corresponds to the pre-VLMM, thereby acquiring a reference preference response for training and a reference non-preference response for training, and generates the 1_st loss by referring to each of the 1_st preference response for training and the 1_st non-preference response included in the 1_st preference feedback data for training and each of the reference preference response for training and the reference non-preference response for training, wherein, at the (iii) of the step of (b), the learning device feeds the video data for training and the query data for training into the ref-VLMM, thereby acquiring the reference preference response for training and the reference non-preference response for training, and generates the k_th loss by referring to each of the k_th preference response for training and the k_th non-preference response for training and each of the reference preference response for training and the reference non-preference response for training.

3. The method of claim 2, wherein the ref-VLMM is a supervised learning model and is a base model for generating the 1_st loss and the k_th loss.

4. The method of claim 1, wherein, at the step of (a), the learning device (i) sets a temperature hyper-parameter value of the pre-VLMM to be a specific temperature hyper-parameter value, wherein the specific temperature hyper-parameter value is greater than or equal to a predetermined threshold, and (ii) feeds the video data for training and the query data for training into the pre-VLMM, thereby allowing the pre-VLMM to generate each of the 1_1-st response for training and the 1_2-nd response for training by using the specific temperature hyper-parameter value, wherein, at the step of (b), the learning device (i) sets a temperature hyper-parameter value of the (k−1)-th trained VLMM to be the specific temperature hyper-parameter value and (ii) feeds the video data for training and the query data for training into the (k−1)-th trained VLMM, thereby allowing the (k−1)-th trained VLMM to generate each of the k_1-st response for training and the k_2-nd response for training by using the specific temperature hyper-parameter value.

5. The method of claim 1, wherein, at the step of (a), the learning device instructs the pre-VLMM to (i) perform embedding on the video data for training and the query data for training in the text form by using an embedding layer, thereby generating a 1_st embedding vector and (ii) generate the 1_1-st response for training and the 1_2-nd response for training by using the 1_st embedding vector through a large language model (LLM), wherein, at the step of (b), the learning device instructs the (k−1)-th trained VLMM to (i) perform embedding on the video data for training and the query data for training by using the embedding layer, thereby generating a k_th embedding vector and (ii) generate the k_1-st response for training and the k_2-nd response for training by using the k-th embedding vector through the LLM.

6. A learning device for training a video large multimodal model (VLMM) by iterative self-retrospective judgment (i-SRT), comprising:
at least one memory that stores instructions; and
at least one processor configured to execute the instructions to perform processes of: (I) (i) (i_1) feeding video data for training and query data for training in a text form into a pre-VLMM, (i_2) instructing the pre-VLMM to generate a 1_st self-retrospective context for training as to the video data for training and to generate a 1_1-st response for training and a 1_2-nd response for training which are corresponding to the query data for training by referring to the video data for training, wherein the 1_2-nd response for training is different from the 1_1-st response for training, and thus (i_3) generating a 1_st preference data set for training including the 1_st self-retrospective context for training, the 1_1-st response for training, the 1_2-nd response for training, the video data for training, and the query data for training, (ii) (ii_1) feeding the 1_st preference data set for training into the pre-VLMM, (ii_2) instructing the pre-VLMM to determine one of the 1_1-st response for training and the 1_2-nd response for training as a 1_st preference response for training and determine another one of the 1_1-st response for training and the 1_2-nd response for training as a 1_st non-preference response for training, and (ii_3) generating a 1_st preference feedback data for training including the 1_st preference response for training, the 1_st non-preference response for training, the video data for training, and the query data for training, and (iii) generating a 1_st loss as to the 1_st preference feedback data for training by using a DPO (Direct Preference Optimization) and updating parameters of the pre-VLMM by using the 1_st loss, thereby generating a 1_st trained VLMM; and (II) (i) (i_1) feeding a (k−1)-th self-retrospective context for training, the video data for training, and the query data for training into a (k−1)-th trained VLMM, wherein the k is an integer increasing from 2 to n, and the n is an integer greater than or equal to 2, (i_2) instructing the (k−1)-th trained VLMM to generate a k_th self-retrospective context for training as to the video data for training by referring to the (k−1)-th self-retrospective context for training and the video data for training and to generate a k_1-st response for training and a k_2-nd response for training which are corresponding to the query data for training by referring to the video data for training, wherein the k_2-nd response for training is different from the k_1-st response for training, and thus (i_3) generating a k_th preference data set for training including the k_th self-retrospective context for training, the k_1-st response for training, the k_2-nd response for training, the video data for training, and the query data for training, (ii) (ii_1) feeding the k_th preference data set for training into the (k−1)-th trained VLMM, (ii_2) instructing the (k−1)-th trained VLMM to determine one of the k_1-st response for training and the k_2-nd response for training as a k_th preference response for training and determine another one of the k_1-st response for training and the k_2-nd response for training as a k_th non-preference response for training, and (ii_3) generating a k_th preference feedback data for training including the k_th preference response for training, the k_th non-preference response for training, the video data for training, and the query data for training, and (iii) generating a k_th loss as to the k_th preference feedback data for training by using the DPO and updating parameters of the (k−1)-th trained VLMM by using the k_th loss, thereby generating a k_th trained VLMM.

7. The learning device of claim 6, wherein, at the (iii) of the process of (I), the processor feeds the video data for training and the query data for training into a reference video large multimodal model (ref-VLMM), wherein the ref-VLMM corresponds to the pre-VLMM, thereby acquiring a reference preference response for training and a reference non-preference response for training, and generates the 1_st loss by referring to each of the 1_st preference response for training and the 1_st non-preference response included in the 1_st preference feedback data for training and each of the reference preference response for training and the reference non-preference response for training, wherein, at the (iii) of the process of (II), the processor feeds the video data for training and the query data for training into the ref-VLMM, thereby acquiring the reference preference response for training and the reference non-preference response for training, and generates the k_th loss by referring to each of the k_th preference response for training and the k_th non-preference response for training and each of the reference preference response for training and the reference non-preference response for training.

8. The learning device of claim 7, wherein the ref-VLMM is a supervised learning model and is a base model for generating the 1_st loss and the k_th loss.

9. The learning device of claim 6, wherein, at the process of (I), the processor (i) sets a temperature hyper-parameter value of the pre-VLMM to be a specific temperature hyper-parameter value, wherein the specific temperature hyper-parameter value is greater than or equal to a predetermined threshold, and (ii) feeds the video data for training and the query data for training into the pre-VLMM, thereby allowing the pre-VLMM to generate each of the 1_1-st response for training and the 1_2-nd response for training by using the specific temperature hyper-parameter value, wherein, at the process of (II), the processor (i) sets a temperature hyper-parameter value of the (k−1)-th trained VLMM to be the specific temperature hyper-parameter value and (ii) feeds the video data for training and the query data for training into the (k−1)-th trained VLMM, thereby allowing the (k−1)-th trained VLMM to generate each of the k_1-st response for training and the k_2-nd response for training by using the specific temperature hyper-parameter value.

10. The learning device of claim 6, wherein, at the process of (I), the processor instructs the pre-VLMM to (i) perform embedding on the video data for training and the query data for training in the text form by using an embedding layer, thereby generating a 1_st embedding vector and (ii) generate the 1_1-st response for training and the 1_2-nd response for training by using the 1_st embedding vector through a large language model (LLM),
wherein, at the process of (II), the processor instructs the (k−1)-th trained VLMM to (i) perform embedding on the video data for training and the query data for training by using the embedding layer, thereby generating a k_th embedding vector and (ii) generate the k_1-st response for training and the k_2-nd response for training by using the k-th embedding vector through the LLM.
